(19) United States
(12) Patent Application Publication
(10) Pub. No.: US 2009/0070661 A1
(43) Pub. Date: Mar. 12, 2009

(54) MANAGEMENT OF USER KNOWLEDGE ABOUT COMPUTER APPLICATIONS

(75) Inventors: Edwin van den Dungen, Heemstede (NL); Martijn Bodeman, Ijmuiden (NL); Robert Meijer, Wassenaar (NL)

Correspondence Address: MCKEE, VOORHEES & SEASE, P.L.C., 801 GRAND AVENUE, SUITE 3200, DES MOINES, IA, 50309-2721, US

(73) Assignee: AFFIXION BV, Heemstede (NL)

(21) Appl. No.: 11/852,416

(22) Filed: Sep. 10, 2007

(51) Int. Cl. G06F 17/30; G06F 3/048; G06F 17/00

(52) U.S. Cl. 715/205; 715/767; 707/5; 707/E17.014

(57) ABSTRACT

A computer readable storage medium storing an article of software thereon, the software having instructions for performing the steps of monitoring an active window, determining if the active window is associated with note information in a database, providing a first visual indicator having a first state to convey that the active window is associated with the note information in the database and a second state to convey that no note information in the database exists for the window, receiving input from a user to open a note area for displaying or entering the note information associated with the active window, and presenting to the user the note area for displaying or entering the note information associated with the active window.

### BACKGROUND OF THE INVENTION

The present invention relates to managing user knowledge relevant to computer applications, more specifically, the present invention relates to software and related methodology for capturing and managing user knowledge associated with computer applications.

The value of capturing knowledge through note-taking is well-established. For example, sticky notes such as POST-IT notes from 3M are well-known for associating a note with another document. There have been various attempts at creating electronic notes to be associated with electronic documents. For example, U.S. Pat. No. 6,437,807 to Berquist et al. is directed towards a software version of post-it notes. Notes may be moved between windows or regions and may be attached to an object. Notes are attached to an attachment site by dragging the note to the attachment site. Berquist et al discloses that drawings, video, and/or sound information can be added to the note (col. 11, lines 21-26).

In addition, various other methods of annotating electronic documents include those such as U.S. Pat. No. 5,845,301 to Rivette et al. which is directed towards software for annotating electronic documents and provides for linking between a particular note and the place in the text associated with the note.

U.S. Pat. No. 5,596,700 to Darnell et al. is directed towards a system of annotating software windows. Darnell discloses creating notes which are permanently and persistently associated with a title text in a window. The notes are either displayed or hidden along with the window.

Yet, problems remain and what is needed is new and improved methods and software for taking capturing and managing user knowledge associated with different windows.

Therefore, it is a primary object, feature, or advantage of the present invention to improve over the state of the art.

It is a further object, feature, or advantage of the present invention to provide software for notes where notes are associated with the title text of a window.

It is a still further object, feature, or advantage of the present invention to provide software for notes where the notes may be shared amongst users.

Another object, feature, or advantage of the present invention is to provide software for notes where a database containing notes may be distributed.

Yet another object, feature, or advantage of the present invention is to provide software for notes which allows each note to contain hypertext links.

One or more of these and/or other objects, features, or advantages of the present invention will become apparent from the specification and claims that follow.

### BRIEF SUMMARY OF THE INVENTION

The preceding presents a simplified summary of aspects of the invention in order to assist in providing a basic understanding of the invention. This summary is not intended to be an extensive overview of the invention, is not intended to identify key or critical elements of the invention or to define the scope of the invention. Nor does this summary necessarily include all of the objects, features, or advantages of the invention.

According to one aspect of the present invention, a computer readable storage medium storing an article of software thereon includes instructions for performing the steps of monitoring an active window and determining if the active window is associated with note information in a database. The software further provides a first visual indicator having a first state to convey that no note information in the database exists for the window and a second state to convey that the active window is associated with the note information in the database. The software further provides for receiving input from a user to open a note area for displaying or entering the note information associated with the active window and presenting to the user the note area for displaying or entering the note information associated with the active window.

According to another aspect of the present invention, a computer-implemented method includes monitoring an active window, determining if the active window is associated with note information in a database, providing a first visual indicator having a first state to convey that the active window is associated with the note information in the database and a second state to convey that no note information in the database exists for the window, receiving input from a user to open a note area for displaying or entering the note information associated with the active window, and presenting to the user the note area for displaying or entering the note information associated with the active window. The database may be a shared database. The shared database may be pre-populated with note information before being receiving input from the user.

### BRIEF DESCRIPTION OF THE DRAWINGS

FIG. 1 is a pictorial representation of a window having a window title and a system tray displaying an icon according to one aspect of the present invention where the icon indicates that there is no current information or knowledge in the database for the active window.

FIG. 2 is a pictorial representation of a window having a window title and a system tray displaying an icon according to one aspect of the present invention where the icon indicates that information or knowledge is available in the database for the active window.

FIG. 3 is a pictorial representation of a window which allows a user to enter or access information in a database, the information associated with the previously active window.

FIG. 4 is a pictorial representation of a window which allows a user to insert a hyperlink into a note area of the window of FIG. 3.

FIG. 5 provides a block diagram of one embodiment of the present invention.

### DETAILED DESCRIPTION OF THE PREFERRED EMBODIMENT

To the accomplishment of the foregoing and related ends, certain illustrative aspects of the innovation are described herein in connection with the following description and the annexed drawings. These aspects are indicative, however, of but a few of the various ways in which the principles of the innovation can be employed and the subject innovation is intended to include all such aspects and their equivalents. Other advantages and novel features of the innovation will become apparent from the following detailed description of the innovation when considered in conjunction with the drawings.

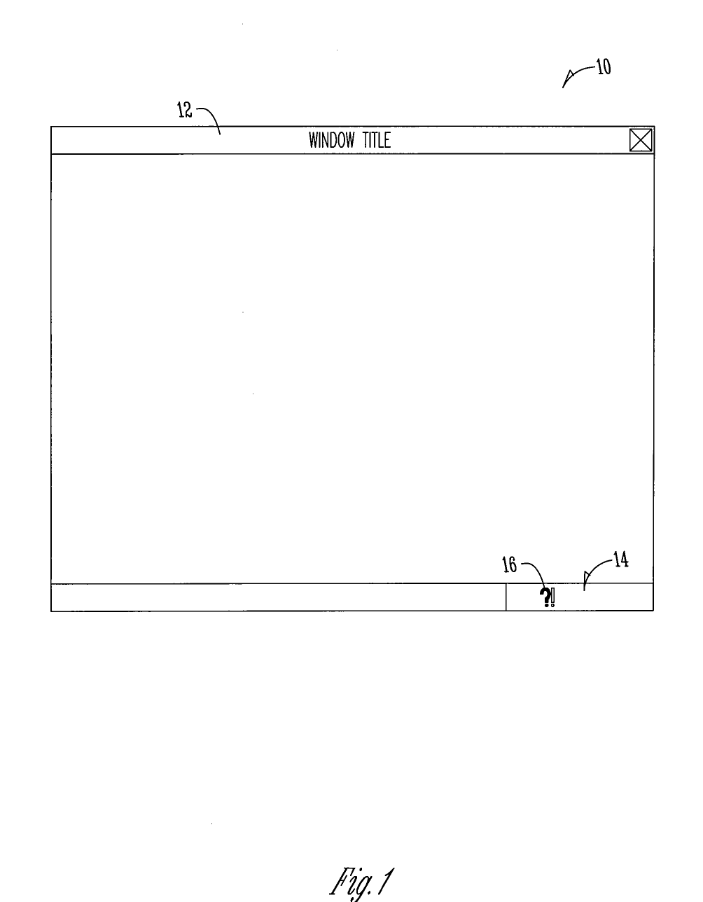

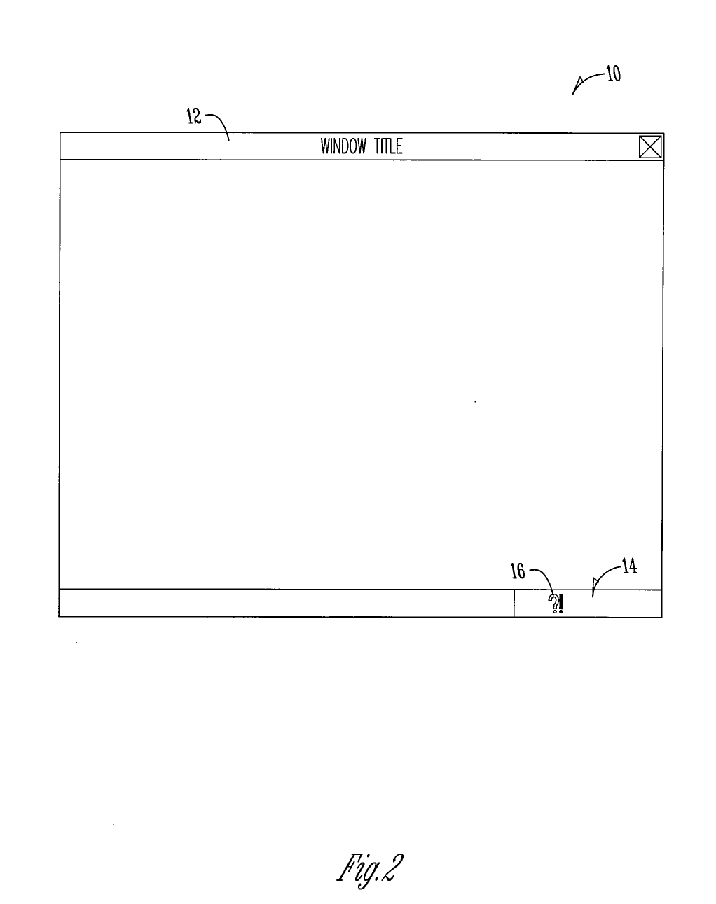

FIG. 1 illustrates one embodiment of a window 10 having a title bar 12 with a title. The window 10 shown is illustrated as maximized, but need not be. A system tray 14 is also shown with an icon 16 in a first state. The icon 16 in the first state indicates that there is no information or notes available for a user, the information or notes associated with the window 10. FIG. 2 illustrates that the icon 16 is in a second state indicating that there is information or notes available for the user for window 10. The icon 16 may be described as having a first state and a second state or may be considered to be two separate icons, one representing a first state and one representing a second state.

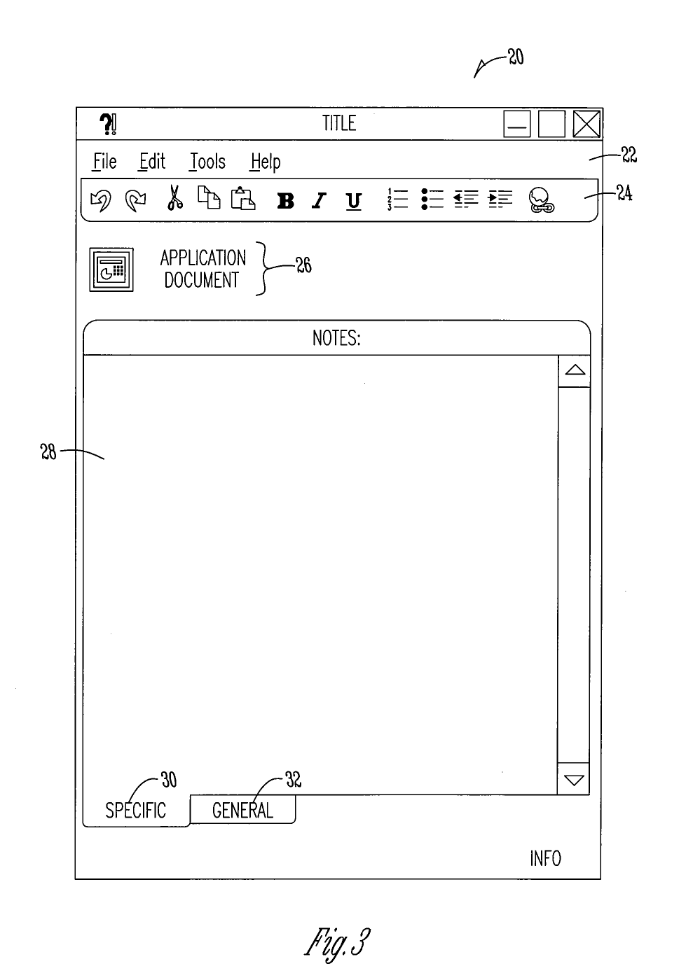

Selection of the icon 16 is one way to open window 20 shown in FIG. 3. The window 20 shown in FIG. 3 includes a menu bar 22, which includes File, Edit, Tools, and Help menu selections. A toolbar 24 is also presented which includes functions such as, but not limited to clipboard functions, text formatting functions, paragraph formatting functions, and a hyperlink function. These functions are merely exemplary. Other functions may also be included. The active window 26 with which notes are associated is identified. A note area 28 is provided in which a user may view or edit information. There is a first tab 30 for specific information and a second tab 32 for general information.

Note that the window includes two tabs. One is labeled “General” and one is labeled “Specific.” Knowledge or information which is associated with the particular title of an application is associated with the “General tab whereas knowledge or information associated with the particular title of a document or project is associated with the “Specific” tab. For example, a user can associate information or knowledge with a word processing application by placing information within the knowledge entry area of the general tab 32. Such information might include notes on tricks or tips that will help one to better use the application. In addition, a user can associate information or knowledge with a particular document by placing information within the knowledge entry area of the specific tab 30. Such information might include notes regarding the content of the document. Note that the window title of a document generally includes both the name of the application as well as the name of the document.

This distinction between general and specific information is very convenient to a user because there are instances where general information should be stored or accessed and instances where specific information should be stored or accessed. In addition, one of the benefits provided is that information associated with the window associated with a document (specific information) does not become a part of the document, as would be the case with adding comments, or annotations to the document.

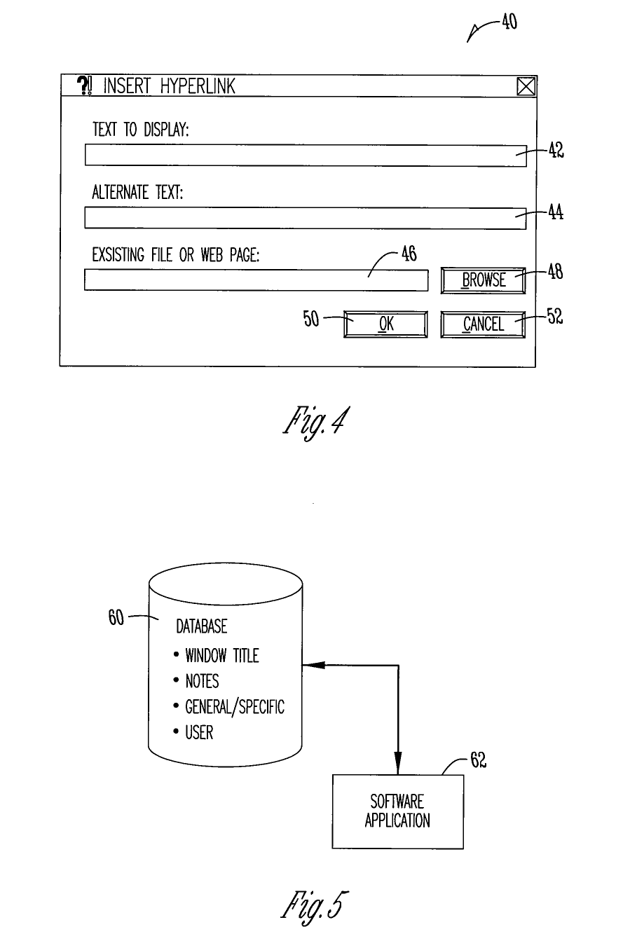

Another aspect of the present invention relates to inserting hyperlinks within the note area. A user may user the toolbar 24 to select to insert a hyperlink or otherwise activate the window or dialog box 40 shown in FIG. 4. A text to display input area 42 allows a user to indicate the text they wish to display. An alternate text input area 44 allows a user to indicate the alternate text they wish to display. An input area 46 allows a user to enter the existing file or web page they wish to link to. A browse button 48 is also provided to assist a user in finding or identifying the file or web page they wish to link to. An OK button 50 and a cancel button 52 are also provided.

FIG. 5 provides a block diagram of one embodiment of the present invention. As shown in FIG. 5, a database 60 contains information about different applications. The information within the database 60 may include a window title or other window identifying information, notes for each window title (including hyperlinks where used), and an indication of whether notes are general or specific. The information within the database 60 may also include information about the user who provided the information. The present invention contemplates that a single database may be personal to a user or may be shared by multiple users. Where multiple users share a database, the source of the information may be identified by user. A software application 62 provides for accessing the database to store or retrieve information about the active window. The software application 62 comprises instructions stored or embodied on a computer readable medium, such as, but not limited to a magnetic medium or an optical medium.

The present invention contemplates that the database 60 may be distributed to one or more users with content concerning different application windows. There are numerous instances where it would be beneficial to provide information in such a manner. For example, the information within the database may be used to provide additional training to users of particular applications, including enterprise-specific or job-specific training. An enterprise may use an application such as a word processor, web browser, spreadsheet application, an accounting application, or other type of software application. Although the application includes detailed information about its use, this information is not presented in a context which is specific to the particular enterprise. Similarly, information about the use of an application does not generally include information or training which is specific to a particular job-function. The present invention provides a means to fill the gap in training, by allowing notes or information pertaining to particular application windows to be stored in a database and made available to a user. Thus, not only can the present invention benefit specific users, but it can be leveraged in a manner to help organizations with their training of employees or other users by providing particular information in particular contexts. The active window establishes the context and then information associated with that context is made available.

The present invention allows a user to save knowledge acquired over time about computer applications in such a way that the user need never search for it. In a windows-based environment, typically at any one point in time, only one application window is active. The active window may be continuously monitored. The software provides for determining whether information corresponding to the active window is available in a database. The software allows a user to retrieve this information or enter new information upon the click of an icon. Thus, the software provides for linking one's knowledge regarding an active window to a database. Knowledge stored within the database may be personal knowledge or may be shared. In addition, databases may be made available to users which already contain information. Where information from multiple users is accessed, the present invention provides for identifying the user who entered or edited the information. This can be accomplished in various ways, including through the use of different tabs for information from different users, color coding for different users, or otherwise.

What has been described above includes examples of the innovation. It is, of course, not possible to describe every conceivable combination of components or methodologies for purposes of describing the subject innovation, but one of ordinary skill in the art may recognize that many further combinations and permutations of the innovation are possible. Accordingly, the innovation is intended to embrace all such alterations, modifications and variations that fall within the spirit and scope of the appended claims.

What is claimed is:

1. A computer readable storage medium storing an article of software thereon, the software having instructions for performing the steps of:
monitoring an active window;
determining if the active window is associated with note information in a database;
providing a first visual indicator having a first state to convey that no note information in the database exists for the window and a second state to convey that the active window is associated with the note information in the database;
receiving input from a user to open a note area for displaying or entering the note information associated with the active window;
presenting to the user the note area for displaying or entering the note information associated with the active window.

2. The computer readable storage medium of claim 1 wherein the software further having instructions for identifying the note area as specific to a document opened with an application associated with the active window or general to the application associated with the active window.

3. The computer readable storage medium of claim 2 wherein the software further having instructions for receiving from the user a hypertext link to include in the note area.

4. The computer readable storage medium of claim 1 wherein the database being a shared database accessible by multiple users.

5. A computer-implemented method, comprising:
monitoring an active window;
determining if the active window is associated with note information in a database;
providing a first visual indicator having a first state to convey that no note information in the database exists for the window and a second state to convey that the active window is associated with the note information in the database;
receiving input from a user to open a note area for displaying or entering the note information associated with the active window;
presenting to the user the note area for displaying or entering the note information associated with the active window.

6. The method of claim 5 wherein the database is a shared database.

7. The method of claim 6 wherein the shared database is pre-populated with note information before being receiving input from the user.

8. The method of claim 5 further comprising receiving from the user a hypertext link to include in the note area.

9. The method of claim 5 wherein the active window is an active dialog box.

10. A method for maintaining notes associated with software applications:
monitoring an active window;
determining if the active window is associated with note information in a shared database shared amongst a plurality of users;
providing a visual indicator to convey whether or not the active window is associated with the note information in the shared database;
receiving input from a user to open a note area for displaying the note information or entering additional note information associated with the active window; and
persistently maintaining the note information in the shared database.

11. The method of claim 10 further comprising receiving from the user a hypertext link to include in the note area.

12. The method of claim 10 wherein the shared database is pre-populated with note information before being used by the plurality of users.
